(19) United States
(12) Patent Application Publication
(10) Pub. No.: US 2026/0184017 A1
(43) Pub. Date: Jul. 2, 2026

(54) CONTINUOUS FIBER-REINFORCED COMPOSITE THREE-DIMENSIONAL PRINTING CONSUMABLE AND PREPARATION METHOD THEREOF, AND THREE-DIMENSIONAL PRINTING METHOD AND ARTICLE MANUFACTURED THEREBY

(71) Applicant: Shanghai NovaStar Technology Co., Ltd., Shanghai (CN)

(72) Inventors: Jinlu Huang, Shanghai (CN); Tingting Zhang, Shanghai (CN)

(21) Appl. No.: 19/429,875

(22) Filed: Dec. 22, 2025

(30) Foreign Application Priority Data
Dec. 26, 2024 (CN) 202411929764.9

(51) Int. Cl. B29C 64/314; B29C 64/118; B29K 105/08; B29K 307/04; B33Y 40/10; B33Y 70/10

(52) U.S. Cl. CPC B29C 64/314; B29C 64/118; B33Y 70/10; B29K 2105/0827; B29K 2105/0836; B29K 2307/04; B33Y 40/10

(57) ABSTRACT

Provided is a continuous fiber-reinforced composite three-dimensional printing consumable and a preparation method thereof, and a three-dimensional printing method and an article manufactured thereby. By adopting a braided sleeve structure, a continuous fiber core material is embedded inside a sheath fiber-braided sleeve through encapsulation or interweaving, enhancing an interfacial bonding force of fibers and results in a three-dimensional printing consumable with excellent mechanical properties. Simultaneously, by adjusting the type, ratio, braiding structure, relative position, and content of the continuous fiber and sheath fiber, a three-dimensional printing consumable with outstanding mechanical properties, thermal performance, special functionality, and processing capabilities could be obtained.

### CROSS REFERENCE TO RELATED APPLICATION

This patent application claims the benefit and priority of Chinese Patent Application No. 202411929764.9, entitled “Continuous fiber-reinforced composite three-dimensional printing consumable and preparation method thereof, and three-dimensional printing method and article manufactured thereby” filed on Dec. 26, 2024, the disclosure of which is incorporated by reference herein in its entirety as part of the present disclosure.

### TECHNICAL FIELD

The present disclosure pertains to the technical field of additive manufacturing, and provides a continuous fiber-reinforced composite three-dimensional printing consumable and a preparation method thereof, and a three-dimensional printing method and an article manufactured thereby.

### BACKGROUND

Three-dimensional printing, also known as additive manufacturing (AM), enable the construction of objects of complicated shapes directly from a digital model by adding materials layer by layer, which significantly shortens product development cycles and reduces manufacturing costs, establishing the AM as a revolutionary technology within the manufacturing field.

Currently, the predominant materials (consumables) used in three-dimensional printing are thermoplastic polymers. These materials exhibit limited mechanical properties and heat resistance, and thus it is difficult for these materials to meet high-performance component demands. To enhance the performance of three-dimensional printed articles, researchers have begun incorporating fillers as reinforcing phases into a polymer matrix. Commonly used fillers include short fibers, glass microspheres, and carbon nanotubes, etc. However, achieving controlled dispersion and orientation of the fillers such as short fibers within the polymer matrix is challenging. Consequently, there is a limited reinforcing effect, which generally fails to achieve a significant improvement in the mechanical properties of printed articles.

Compared with short fibers, continuous fibers possess higher strength and modulus, exhibiting excellent mechanical properties along the fiber direction. Nevertheless, inorganic continuous fibers typically have smooth and inert surfaces, leading to poor interfacial adhesion (bonding) with the polymer matrix. The weak interface prevents the composite from achieving its full potential performance. Existing approaches for printing with continuous fibers generally follow two routes. The first route involves using pre-impregnated continuous fibers (prepreg) to form printable filaments. The second route employs feeding through separate feed channels for the continuous fiber and the polymer fiber during the printing, combining and compositing them at the print head. However, the direct use of pre-impregnated continuous fiber is limiting because the continuous fiber cannot be coated with a sufficient amount of the polymer matrix. The insufficiency can easily lead to cracking in structures printed directly from such fiber. Conversely, in the dual-channel printing method where the continuous fiber and the polymer fiber are fed separately, the bonding between the continuous fiber and the polymer matrix is also limited due to the single-sided contact nature during printing. This inadequate bonding negatively impacts the overall mechanical performance of a printed part.

### SUMMARY

An objective of the present disclosure is to provide a continuous fiber-reinforced composite three-dimensional printing consumable and a preparation method thereof, and a three-dimensional printing method and an article manufactured thereby. In the present disclosure, the three-dimensional printing consumable enhances a bonding force between a continuous fiber and a polymer fiber, thereby improving the mechanical properties of a three-dimensional printed article, while also enabling stable supply and precise positioning of the continuous fiber.

To achieve the above objective, the present disclosure provides the following technical solutions:
The present disclosure provides a continuous fiber-reinforced composite three-dimensional printing consumable, including a continuous fiber core material and a sheath fiber-braided sleeve; where the continuous fiber core material is wrapped in a lumen of the sheath fiber-braided sleeve, and/or the continuous fiber core material is interweaved within a sleeve wall of the sheath fiber-braided sleeve;
the continuous fiber core material includes one or more selected from the group consisting of a carbon fiber, a glass fiber, a basalt fiber, a polymer fiber, a metal fiber, a ceramic fiber, and a bio-based fiber; and
a sheath fiber used for the sheath fiber-braided sleeve is a polymer fiber.

In some embodiments, the sheath fiber includes one or more selected from the group consisting of a polyamide (PA) fiber, a polypropylene (PP) fiber, a polyethylene (PE) fiber, a polylactic acid (PLA) fiber, a polycaprolactone (PCL) fiber, a polyvinyl alcohol (PVA) fiber, a polyether ether ketone (PEEK) fiber, a polyimide (PI) fiber, a polyphenylene sulfide (PPS) fiber, a polycarbonate (PC) fiber, a polyethylene terephthalate (PET) fiber, a polyvinyl chloride (PVC) fiber, a blended polymer fiber, and a modified polymer fiber; and
a number of layers in the sleeve wall of the sheath fiber-braided sleeve is ≥1; and a mass ratio of the continuous fiber core material to the sheath fiber-braided sleeve is in a range of 1-80:20-99.

In some embodiments, the polymer fiber used in the continuous fiber core material includes one or more selected from the group consisting of an aramid fiber, a poly(p-phenylene benzobisoxazole) (PBO) fiber, a PE fiber, a polyester fiber, a PI fiber, and a PA fiber;
the metal fiber includes one or more selected from the group consisting of a copper fiber, an aluminum fiber, and a tungsten fiber;
the ceramic fiber includes an alumina fiber and/or a silicon carbide fiber;
the bio-based fiber includes a bamboo fiber and/or a flax fiber; and
the continuous fiber core material is selected from the group consisting of a fiber monofilament and a fiber bundle; and a number of at least one of the continuous fiber core material is at least one.

In some embodiments, the continuous fiber core material includes a functional polymer fiber; and the functional polymer fiber includes one or more selected from the group consisting of a conductive fiber, a flame-retardant fiber, an antibacterial fiber, and a fluorescent fiber.

In some embodiments, under a condition that the continuous fiber core material is wrapped in the lumen of the sheath fiber-braided sleeve, a distribution pattern of the continuous fiber core material in a cross-section of the continuous fiber-reinforced composite three-dimensional printing consumable is selected from the group consisting of central distribution, eccentric distribution, and multi-core distribution; and
under a condition that the distribution pattern is the eccentric distribution, the continuous fiber-reinforced composite three-dimensional printing consumable further includes an auxiliary positioning fiber; the auxiliary positioning fiber and the continuous fiber core material are collectively wrapped in the lumen of the sheath fiber-braided sleeve; and the auxiliary positioning fiber and the continuous fiber core material are arranged in parallel or intertwined.

The present disclosure further provides a method for preparing the continuous fiber-reinforced composite three-dimensional printing consumable, including following steps:
braiding according to a predetermined structure using the sheath fiber and the continuous fiber core material as raw materials to obtain the continuous fiber-reinforced composite three-dimensional printing consumable; alternatively,
braiding according to the predetermined structure using the sheath fiber, the continuous fiber core material, and the auxiliary positioning fiber as raw materials to obtain the continuous fiber-reinforced composite three-dimensional printing consumable; where
the braiding is performed by weaving or knitting.

In some embodiments, a number of spindles for the weaving is 4 to 200; a number of needles for the knitting is 4 to 200; an angle of the weaving or the knitting is in a range of 5° to 85°; and the sheath fiber is arranged in an annular pattern or a spiral pattern.

In some embodiments, the preparation method further includes: after the braiding is completed, subjecting a consumable obtained from the braiding to a setting treatment and/or a surface treatment; where a process for the setting treatment includes one selected from the group consisting of a heat treatment, a solvent treatment, a steam fumigation treatment, and an ultraviolet curing treatment; and
a process for the surface treatment is one selected from the group consisting of a plasma treatment and formation of a functional layer on a surface of the consumable obtained from the braiding; and the functional layer includes one or more selected from the group consisting of a lubricating layer, an anti-oxidation layer, an anti-static layer, a flame-retardant layer, a conductive layer, and an antibacterial layer.

The present disclosure further provides a three-dimensional printing method, including:
conducting three-dimensional printing using the continuous fiber-reinforced composite three-dimensional printing consumable or the continuous fiber-reinforced composite three-dimensional printing consumable prepared by the method.

The present disclosure further provides a three-dimensional printed article obtained by the three-dimensional printing method.

The present disclosure provides a continuous fiber-reinforced composite three-dimensional printing consumable, including a continuous fiber core material and a sheath fiber-braided sleeve; where the continuous fiber core material is wrapped in a lumen of the sheath fiber-braided sleeve, and/or the continuous fiber core material is interweaved within a sleeve wall of the sheath fiber-braided sleeve; the continuous fiber core material is one or more selected from the group consisting of a carbon fiber, a glass fiber, a basalt fiber, a polymer fiber, a metal fiber, a ceramic fiber, and a bio-based fiber; and a sheath fiber used for the sheath fiber-braided sleeve is a polymer fiber. The present disclosure has the following beneficial effects:

Enhanced interfacial bonding and improved mechanical properties: the present disclosure introduces, for the first time, braided sleeve technology into the preparation of consumables for three-dimensional printing. By embedding continuous fibers inside a sheath fiber-braided sleeve through encapsulation or interweaving, stable embedding of the continuous fibers and effective encapsulation by the sheath fibers are achieved. This enhances the interfacial bonding force between the continuous fibers and the sheath fibers, thereby improving the mechanical properties of the consumables for three-dimensional printing, including tensile strength, bending strength, and impact toughness.

Prevention of fiber breakage, enabling stable supply and precise positioning of continuous fibers: in the field, stable supply and precise positioning of continuous fibers during the three-dimensional printing represent technical challenges. Traditional methods using continuous fibers for three-dimensional printing are prone to fiber breakage, entanglement, and deviation, which adversely affect printing quality. In the present disclosure, the continuous fiber core material is encapsulated within the sheath fiber-braided sleeve or interweaved into a sleeve wall of the sheath fiber-braided sleeve, providing a certain displacement tolerance. This allows adaptation to minor stress variations during printing, preventing fiber breakage, entanglement, and deviation, thereby improving print quality.

Improved material compatibility and reduced internal stress: furthermore, by selecting sheath fiber materials compatible with the continuous fiber, the present disclosure optimizes the thermal expansion coefficient and melting characteristics between the continuous fiber and the matrix. This reduces internal stress during processing and use, preventing deformation and cracking of the printed articles.

Flexible structural design: additionally, the preparation method is applicable to various combinations of continuous fibers and sheath fibers. The sheath fiber-braided sleeve can be a multi-layered structure, and multiple continuous fiber cores can be incorporated. Parameters such as the number of braided sleeve layers, the quantity of continuous fiber cores, fiber types, and arrangement modes can be adjusted according to practical requirements. This offers a high degree of customization to meet performance demands across different application scenarios, broadening the material's range of applications.

The present disclosure further provides a preparation method of the continuous fiber-reinforced composite three-dimensional printing consumable. The preparation method described herein is simple, easy to control, suitable for mass production, and low in cost, facilitating the widespread application of continuous fiber-reinforced composite three-dimensional printing consumable. Furthermore, by precisely controlling weaving or knitting parameters, uniform fiber distribution and directional alignment are achieved, which reduces anisotropy in mechanical properties and enhances the reliability and consistency of the printed articles.

The present disclosure further provides a three-dimensional printing method, including: conducting three-dimensional printing using the continuous fiber-reinforced composite three-dimensional printing consumable. The three-dimensional printing consumable possesses appropriate flexibility and stable dimensions, ensuring a smooth printing process without the need for frequent equipment adjustments or printing interruptions. This improves printing speed and efficiency, meeting the demands of industrial production. Moreover, traditional methods employing continuous fibers for three-dimensional printing require specially designed print heads, fiber supply systems, and control software, resulting in high equipment costs and complex processes. In contrast, by pre-embedding the continuous fiber within the consumable, the printing equipment eliminates the need for an additional fiber supply system and can be directly used with existing Fused Deposition Modeling (FDM) three-dimensional printers without special modifications. This lowers the application barrier, reduces equipment costs, and decreases process complexity.

### BRIEF DESCRIPTION OF THE DRAWINGS

To describe the technical solutions in examples of the present disclosure or in the prior art more clearly, the accompanying drawings required in the examples are briefly described below. Apparently, the accompanying drawings in the following description show merely some examples of the present disclosure, and other drawings can still be derived from these accompanying drawings by those of ordinary skill in the art without creative efforts.

FIG. 1A to FIG. 1B show schematic diagrams of a preparation process (FIG. 1A) and structure (FIG. 1B) of a continuous fiber-reinforced composite three-dimensional printing consumable with a weaved sleeve structure according to an embodiment of the present disclosure;

FIG. 2 shows a schematic diagram of a structure of a continuous fiber-reinforced composite three-dimensional printing consumable with a knitted sleeve structure according to an embodiment of the present disclosure;

FIG. 3A to FIG. 3H show schematic diagrams of a structure of a continuous fiber-reinforced composite three-dimensional printing consumable with a multi-layer braided sleeve structure according to an embodiment of the present disclosure, where 1 denotes the continuous fiber core material, 3 denotes the braided sleeve layer (which may be multi-layered), and 4 denotes the knitted sleeve layer (which may be multi-layered);

FIG. 4A to FIG. 4F show schematic diagrams of a structure of a continuous fiber-reinforced composite three-dimensional printing consumable with an eccentrically-distributed continuous fiber core material provided by the present disclosure, where 1 denotes the continuous fiber core material, 2 denotes the auxiliary positioning fiber for eccentric positioning, 3 denotes the weaved sleeve layer, and 4 denotes the knitted sleeve layer;

FIG. 5A to FIG. 5C show schematic diagrams of structures of continuous fiber-reinforced composite three-dimensional printing consumables with different weaving angles or pitches, where the grid density in the diagram represents the pitch; and

FIG. 6 shows a schematic diagram of the heat treatment, where 5 denotes a thermal insulation layer, 6 denotes a heating layer, and 7 denotes a die orifice.

### DETAILED DESCRIPTION OF THE EMBODIMENTS

The present disclosure provides a continuous fiber-reinforced composite three-dimensional printing consumable, including a continuous fiber core material and a sheath fiber-braided sleeve; where the continuous fiber core material is wrapped in a lumen of the sheath fiber-braided sleeve, and/or the continuous fiber core material is interweaved within a sleeve wall of the sheath fiber-braided sleeve;
the continuous fiber core material includes one or more selected from the group consisting of a carbon fiber, a glass fiber, a basalt fiber, a polymer fiber, a metal fiber, a ceramic fiber, and a bio-based fiber; and
a sheath fiber used for the sheath fiber-braided sleeve is a polymer fiber.

In the present disclosure, unless otherwise specified, all raw material components are commercially available products well known to those skilled in the art.

In the present disclosure, the sheath fiber used for the sheath fiber-braided sleeve is a polymer fiber. Specifically, in some embodiments, the sheath fiber includes one or more of PA fiber, PP fiber, PE fiber, PLA fiber, PCL fiber, PVA fiber, PEEK fiber, PI fiber, PPS fiber, PC fiber, PET fiber, PVC fiber, blended polymer fiber, and modified polymer fiber. In some embodiments, the PA fiber is PA6 fiber. The blended polymer fiber specifically is a fiber formed from a blend of at least two polymers selected from PA, PP, PE, PLA, PCL, PVA, PEEK, PI, PPS, PC, PET, and PVC. In some embodiments, the modified polymer fiber is obtained by modifying a polymer matrix with a modifying agent. The polymer matrix specifically includes one or more of PA, PP, PE, PLA, PCL, PVA, PEEK, PI, PPS, PC, PET, and PVC. In some embodiments, the modifying agent includes one or more of inorganic fillers, short fibers, a nanomaterial, magnetic particles, and an antioxidant. In some embodiments, the inorganic filler includes one or more selected from carbon black, a metal oxide powder, and a mineral powder. In some embodiments, the short fibers include one or more of glass fiber, carbon fiber, and aramid fiber. In some embodiments, the nanomaterial includes one or more selected from carbon nanotubes, graphene, and metal nanowires. There are no specific requirements for the magnetic particles and the antioxidant, and those commonly known to a person skilled in the art may be used. In the disclosure, using inorganic fillers as the modifying agent can enhance the mechanical properties, thermal stability, and wear resistance of the polymer matrix. Using short fibers as the modifying agent can enhance the tensile strength, impact resistance, and fatigue resistance of the polymer matrix. Using nanomaterials as the modifying agent can enhance the mechanical, wear, electrical, and thermal properties of the polymer matrix. Incorporating magnetic particles can impart magnetic properties to the polymer matrix, while adding the antioxidant can improve the anti-aging performance of the polymer matrix. In specific examples, a particular polymer fiber can be selected according to process requirements and performance needs. For example, using PP fiber (melting point 145° C.) and PCL fiber (melting point approx. 65° C.), which have lower melting points, is suitable for low-temperature processing. Using PEEK fiber (melting point 343° C.), which has a higher melting point, is suitable for high-temperature applications. Using a combination of PLA fiber (melting point 170° C.) and PA6 fiber (melting point 220° C.) can balance processing temperature and material performance.

In some embodiments of the present disclosure, the sheath fiber has a diameter of 10 μm to 300 μm. In specific embodiments, it may be 15 μm, 25 μm, 50 μm, 100 μm, or 200 μm; in some embodiments, a number of layers in the sleeve wall of the sheath fiber-braided sleeve is ≥1, that is to say, the sheath fiber-braided sleeve may have a single-layer structure or a multi-layer nested structure. Specifically, in some embodiments, the sleeve wall of the sheath fiber-braided sleeve has 1 to 20 layers. In specific examples, it may be 2 layers, 3 layers, 5 layers, 10 layers, or 15 layers. In the present disclosure, under a condition that the sleeve wall of the sheath fiber-braided sleeve is of more than one layer structure, the types of sheath fibers in each layer and the types of continuous fiber core materials interweaved therein may be the same or different to achieve specific performance combinations and functional requirements.

In the present disclosure, a mass ratio of the continuous fiber core material to the sheath fiber-braided sleeve is in a range of 1-80:20-99. In specific examples, it may be 10:90, 20:80, 25:75, 30:70, 50:50, 55:45, 70:30, or 80:20.

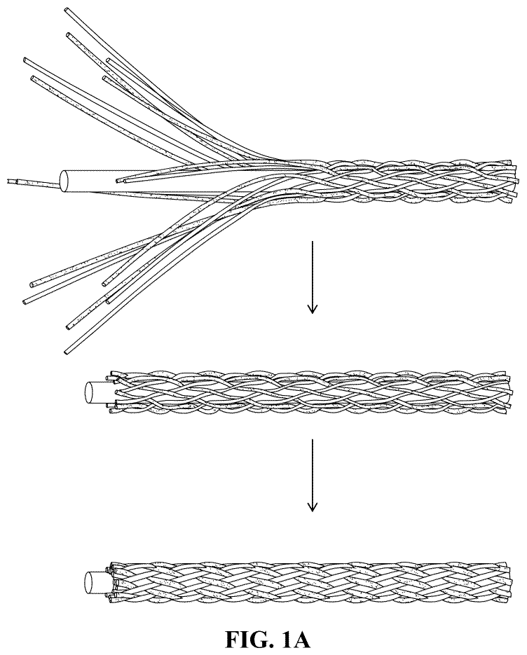

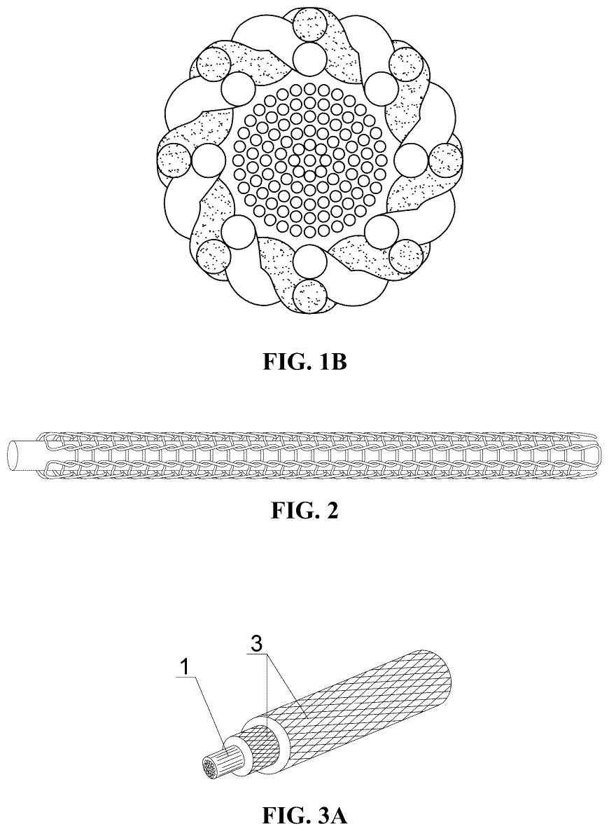

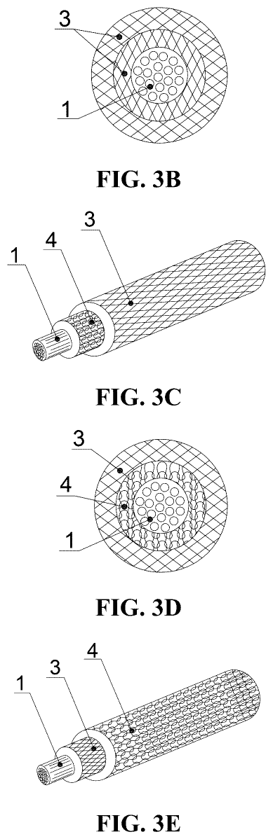

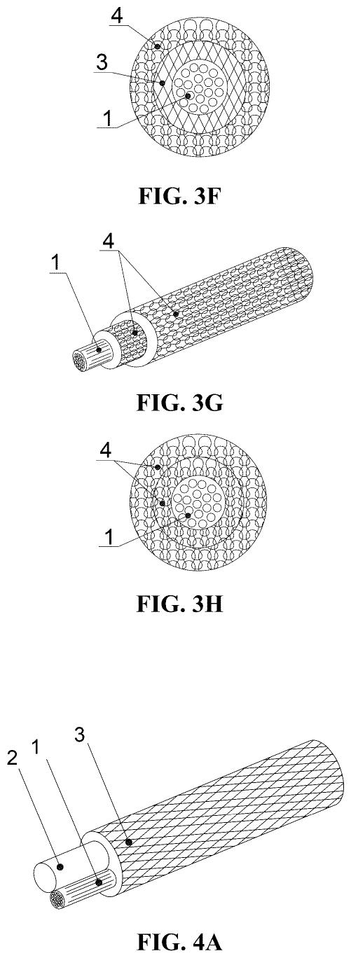

In the present disclosure, the sheath fiber-braided sleeve may specifically be a weaved sleeve and/or a knitted sleeve. Under a condition that the sleeve wall of the sheath fiber-braided sleeve is of more than one layer structure, there are no specific requirements regarding the specific braiding mode of each layer; the braiding modes of each layer may be the same or different. Furthermore, under a condition that the continuous fiber core material is interweaved within the sheath fiber-braided sleeve, the type of continuous fiber, the type of sheath fiber, the weaving angle, and the weaving or knitting density used in each layer may differ to achieve specific performance combinations and functional requirements. For example, in specific examples, under a condition that the sheath fiber-braided sleeve is of a 2-layer structure and the continuous fiber core is interweaved within the sleeve wall, the inner sleeve wall may be carbon fiber bundle interweaved with PLA fiber, while the outer sleeve wall may be glass fiber interweaved with PA fiber. The braiding angle in the inner sleeve wall may be 30°, and the braiding angle in the outer fiber layer may be 60°. FIG. 1A to FIG. 1B show schematic diagrams of a preparation process and structure of a continuous fiber-reinforced composite three-dimensional printing consumable with a braided sleeve structure according to an embodiment of the present disclosure; FIG. 2 shows a schematic diagram of a structure of a continuous fiber-reinforced composite three-dimensional printing consumable with a weaved sleeve structure according to an embodiment of the present disclosure; FIG. 3A to FIG. 3H shows schematic diagrams of a preparation process and structure of a continuous fiber-reinforced composite three-dimensional printing consumable with a multi-layer braided sleeve structure according to an embodiment of the present disclosure.

In some embodiments of the present disclosure, the continuous fiber core material includes one or more selected from the group consisting of carbon fiber, glass fiber, basalt fiber, polymer fiber, metal fiber, ceramic fiber, and bio-based fiber. Under a condition that the continuous fiber core material includes a polymer fiber, the polymer fiber includes one or more selected from the group consisting of aramid fiber, PBO fiber, PE fiber, polyester fiber, PI fiber, and PA fiber. In some embodiments, the metal fiber includes one or more selected from the group consisting of copper fiber, aluminum fiber, and tungsten fiber. In some embodiments, the ceramic fiber includes alumina fiber and/or silicon carbide fiber. In some embodiments, the bio-based fiber includes bamboo fiber and/or flax fiber. In specific examples, the continuous fiber core material is carbon fiber, glass fiber, a carbon fiber/glass fiber hybrid fiber, or a basalt/aramid hybrid fiber. In some embodiments, in the carbon fiber/glass fiber hybrid fiber, a weight ratio of the carbon fiber to the glass fiber is 1:1. In some embodiments, in the basalt/aramid hybrid fiber, a weight ratio of the basalt fiber to the aramid fiber is 1:1.

In some embodiments of the present disclosure, the continuous fiber core material includes a functional polymer fiber. In some embodiments, the functional polymer fiber includes one or more selected from the group consisting of conductive fiber, flame-retardant fiber, antibacterial fiber, and fluorescent fiber. By employing functional polymer fibers, specific functional properties can be imparted to the three-dimensional printing consumable. In examples, the functional polymer fiber may be distributed within different fiber layers of the braided sleeve wall to achieve functional gradients. The continuous fiber-reinforced composite three-dimensional printing consumable provided in the present disclosure is suitable for various combinations of continuous fibers and sheath fibers, allows selection of an appropriate material system according to requirements, offers a high degree of customization, and broadens the application range of the material.

In some embodiments of the present disclosure, the continuous fiber core material is a monofilament or a fiber bundle. In some embodiments, the monofilament has a diameter of 2 μm to 800 μm; in specific examples, it may be 5 μm, 7 μm, 10 μm, 100 μm, 300 μm, or 500 μm. In some embodiments, the number of monofilaments in the fiber bundle ranges from 1K to 50K; in specific examples, it may be 2K, 5K, 10K, 20K, 30K, or 40K.

In some embodiments of the present disclosure, the number of continuous fiber core materials is ≥1, preferably from 1 to 100, and specifically may be 1, 2, 5, 10, 30, 50, or 80.

In some embodiments of the present disclosure, under the condition that the continuous fiber core material is wrapped within the lumen of the sheath fiber-braided sleeve, its distribution pattern in the cross-section of the consumable is central distribution, eccentric distribution, or multi-core distribution. In specific examples, through the multi-core distribution, i.e., introducing multiple bundles of continuous fibers into the same filament through plying or combining, can further enhance the performance and functional diversity of the three-dimensional printing consumable.

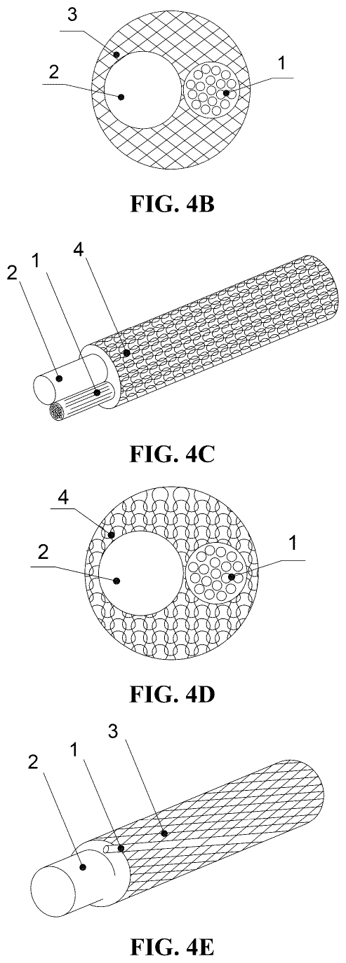

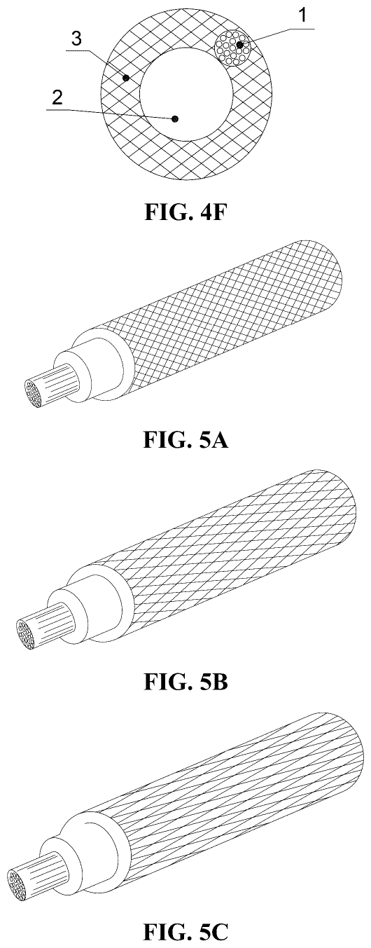

In some embodiments of the present disclosure, under the condition that the distribution pattern is eccentric distribution, the composite three-dimensional printing consumable further includes an auxiliary positioning fiber. In some embodiments, the auxiliary positioning fiber and the continuous fiber core material are collectively wrapped within the lumen of the sheath fiber-braided sleeve. In some embodiments, the auxiliary positioning fiber and the continuous fiber core material are in parallel arrangement or mutually winding. In some embodiments, the auxiliary positioning fiber is made of a material selected from a material of the continuous fiber core material or a material of the sheath fiber, which will not be reiterated here. In some embodiments, the auxiliary positioning fiber has a diameter of 2 μm to 800 μm; in specific examples, it may be 5 μm, 10 μm, 100 μm, 300 μm, or 500 μm. Schematic diagrams of the structure of the continuous fiber-reinforced composite three-dimensional printing consumable with an eccentrically distributed continuous fiber core according to an embodiment of the present disclosure are shown in FIG. 4A to FIG. 4F.

In some embodiments of the present disclosure, the continuous fiber-reinforced composite three-dimensional printing consumable has a diameter of 0.1 mm to 10 mm. In specific examples, it may be 1.75 mm or 2.85 mm.

The present disclosure further provides a method for preparing the continuous fiber-reinforced composite three-dimensional printing consumable, including following steps:
braiding according to a predetermined structure using the sheath fiber and the continuous fiber core material as raw materials to obtain the continuous fiber-reinforced composite three-dimensional printing consumable; alternatively,
braiding according to the predetermined structure using the sheath fiber, the continuous fiber core material, and the auxiliary positioning fiber as the raw materials to obtain the continuous fiber-reinforced composite three-dimensional printing consumable; where
the braiding is performed by weaving or knitting.

In some embodiments of the present disclosure, the number of spindles for weaving ranges from 4 to 200; in specific examples, it may be 10, 30, 50, 100, or 150. In some embodiments, the number of needles for knitting ranges from 4 to 200; in specific examples, it may be 10, 30, 50, 100, or 150. In some embodiments, the speed of weaving or knitting ranges from 10 rpm to 800 rpm; in specific examples, it may be 20 rpm, 30 rpm, 100 rpm, 300 rpm, or 500 rpm. In some embodiments, a weaving angle or a knitting angle ranges from 5° to 85°; in specific examples, it may be 10°, 30°, 50°, 60°, or 70°. In some embodiments, a pitch of weaving is in a range of 0.1 mm to 10 mm. By adjusting the braiding angle and braiding density, the flexibility, strength, and surface quality of the filament can be controlled to achieve specific performance combinations and functional requirements. For example, when the braiding angles are set to 30°, 45°, and 60° respectively, a smaller weaving angle (30°) results in more parallel alignment of fibers in the axial direction, increasing the material's flexibility and toughness, and making it suitable for applications requiring bending. A larger weaving angle (60°) results in tighter radial interweaving of fibers, enhancing the material's strength and stability, making it suitable for high-strength applications. FIG. 5A to FIG. 5C shows schematic diagrams of structures of continuous fiber-reinforced composite three-dimensional printing consumables with different weaving angles or pitches.

In some embodiments of the present disclosure, the sheath fiber is arranged in an annular or a spiral pattern. In some embodiments, during braiding, the tension of the continuous fiber core material ranges from 0.1 N to 10 N; in specific examples, it may be 0.5 N, 1 N, 3 N, 5 N, or 8 N. In some embodiments, the tension of the sheath fiber ranges from 0.1 N to 10 N; in specific examples, it may be 0.5 N, 1 N, 3 N, 5 N, or 8 N. The continuous fiber core material and sheath fiber are introduced at an appropriate tension during weaving or knitting to ensure stable supply and arrangement of the fibers. By adjusting the fiber guiding device of a weaving machine or a knitting machine, the continuous fibers can be distributed at any position in the cross-section of the filament to meet special requirements such as functional gradients and local reinforcement.

In the present disclosure, there are no specific requirements for the particular braiding mode, and braiding is conducted according to the structure of the target three-dimensional printing consumable. Specifically, under the condition that the continuous fiber core material is wrapped within the lumen of the sheath fiber-braided sleeve, the sheath fibers are weaved or knitted over the surface of the continuous fiber core material. In some embodiments, under the condition that the continuous fiber core material is interweaved within the sleeve wall of the sheath fiber-braided sleeve, the sheath fibers and continuous fiber core material are weaved or knitted into a tubular structure. In some embodiments, under the condition that the distribution pattern of the continuous fiber core material is eccentric, the sheath fibers are weaved or knitted over the surface of the continuous fiber core material and the auxiliary positioning fiber.

In some embodiments of the present disclosure, during the weaving or knitting, the distribution position of the continuous fiber core material is adjusted through core configuration methods such as single-strand, combining, or plying, to achieve central distribution, eccentric distribution, or multi-core distribution, meeting the requirements for functional gradients and local reinforcement.

In some embodiments of the present disclosure, after the braiding is completed, the method further includes subjecting an obtained consumable to a setting treatment and/or a surface treatment, which are described in detail below.

In some embodiments of the present disclosure, a process for the setting treatment includes a heat treatment, a solvent treatment, a steam fumigation treatment, or an ultraviolet (UV) curing treatment. In specific examples, a corresponding setting treatment is selected based on the characteristics of polymer fiber used in the sheath fiber-braided sleeve.

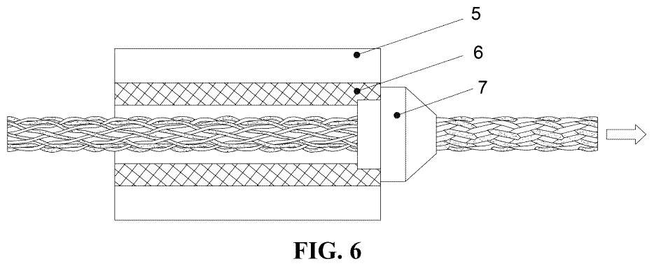

In the present disclosure, the heat treatment is applicable to thermoplastic polymer fibers. In some embodiments, the heat treatment is conducted at a temperature ranging from 50° C. below the melting point of the polymer fiber to 10° C. above the melting point of the polymer fiber, specifically preferably from 50° C. to 400° C. In some embodiments, the heat treatment is conducted for 0.1 min to 60 min; in specific examples, it may be 10 s, 1 min, 5 min, 10 min, 30 min, or 50 min. In some embodiments of the present disclosure, under the condition that multiple different polymers are used in the sheath fiber, the heat treatment is conducted in stages, sequentially conducting heat treatment according to the melting points of different polymers. In specific examples, the heat treatment is conducted using a tubular furnace. In some embodiments, a furnace wall of the tubular furnace consists, from the inside to the outside, of a heating layer and a thermal insulation layer, and an outlet end of the tubular furnace is equipped with a die orifice. In some embodiments, the braided material is passed through the tubular furnace at a constant speed for heat treatment. The speed at which the material passes through the tubular furnace can be controlled according to the target heat treatment duration, and may specifically be 0.1 m/min to 10 m/min. FIG. 6 shows a schematic diagram of a heat treatment process according to an embodiment of in the present disclosure.

In specific examples of the present disclosure, to avoid material degradation or performance decline due to excessive treatment, the temperature and duration of the heat treatment must be strictly controlled. Specifically, appropriate heat treatment temperature and time are selected according to the melting point of the chosen polymer fiber. For example, when the sheath fiber is PP fiber, the heat treatment is conducted at 180° C. for 5 min; when the sheath fiber is PEEK fiber, the heat treatment is conducted at 370° C. for 10 min.

In the present disclosure, the solvent treatment is applicable to soluble polymer fibers. In some embodiments, a solvent used for the solvent treatment is water and/or an organic solvent. In some embodiments, the organic solvent includes one or more of ethanol, acetone, dichloromethane (DCM), toluene, and cyclohexanone. In some embodiments, under the condition that the solvent is a mixture of water and an organic solvent, a volume fraction of the organic solvent in the mixed solvent is not less than 0.1% and less than 100%, and may specifically be 1%, 5%, 20%, 50%, 80%, or 90%. In some embodiments, the solvent treatment is conducted at a temperature ranging from room temperature to 100° C.; in specific examples, it may be 30° C., 50° C., or 80° C. In some embodiments, the solvent treatment is conducted for 0.1 min to 60 min; in specific examples, it may be 1 min, 5 min, 10 min, 30 min, or 50 min. In specific examples, under the condition that the sheath fiber is PVA fiber, pure water is used for solvent treatment preferably at 85° C. for preferably 5 min, ensuring moderate dissolution of the PVA fiber under these conditions.

In the present disclosure, the steam fumigation treatment is applicable to polymer fibers requiring softening, such as PLA fiber. In some embodiments, a steam used for the treatment is specifically water steam. In some embodiments, the steam fumigation treatment is conducted at a temperature of 50° C. to 300° C.; in specific examples, it may be 100° C. or 200° C. In some embodiments, the steam fumigation treatment is conducted for 0.1 min to 60 min; in specific examples, it may be 1 min, 5 min, 10 min, 30 min, or 50 min.

In the present disclosure, the UV curing treatment is applicable to photosensitive polymer fibers. In some embodiments, the UV curing treatment is performed by irradiating for 0.1 min to 60 min; in specific examples, it may be 1 min, 5 min, 10 min, 30 min, or 50 min.

In some embodiments of the present disclosure, under the condition that heat treatment or steam fumigation treatment is adopted for the setting treatment, a treated material is cooled afterward. In some embodiments, the cooling means include air cooling, water cooling, or staged cooling. The cooling rate can be adjusted according to the material characteristics to avoid internal stress and deformation. In some embodiments, under the condition that solvent treatment is adopted for the setting treatment, the treated material is dried afterward. In some embodiments, the drying is performed at a temperature of 20° C. to 150° C.; in specific examples, it may be 40° C., 70° C., 100° C., or 130° C. In some embodiments, the drying is performed for 0.1 h to 24 h; in specific examples, it may be 1 h, 5 h, 10 h, 15 h, or 20 h. Drying ensures complete evaporation of the solvent and improves the dimensional stability of the three-dimensional printing consumable.

In the present disclosure, the setting treatment causes partial melting, softening, or dissolution of the sheath fiber, which then cover the continuous fibers, forming a dense structure and enhancing the structural stability of the three-dimensional printing consumable.

In some embodiments of the present disclosure, a process for the surface treatment includes plasma treatment or the application of a functional layer on the surface of the braided consumable. In some embodiments, the functional layer includes one or more of a lubricating layer, an anti-oxidation layer, an anti-static layer, a flame-retardant layer, a conductive layer, and an antibacterial layer. A process for preparing the functional layer includes spraying, dip coating, brush coating, or chemical deposition. Surface treatment can be conducted after the setting treatment, or directly on the braided material if no setting treatment is required. Surface treatment can improve the feed performance, weather resistance, and functional properties of the three-dimensional printing consumable.

In the present disclosure, after obtaining the three-dimensional printing consumable, the method further includes winding. In some embodiments, the winding is conducted using an automatic winding machine. In some embodiments, the tension during winding ranges from 0.1 N to 100 N; in specific examples, it may be 1 N, 5 N, 10 N, 30 N, 50 N, or 80 N. In some embodiments, an automatic winding machine is used to coil the prepared three-dimensional printing consumable onto spools for convenient storage and use. During winding, the tension of the three-dimensional printing consumable should remain stable to avoid slack or over-stretching. In some embodiments, a storage environment for the three-dimensional printing consumable is dry and protected from light, with a temperature ranging from −20° C. to 50° C.; in specific examples, it may be 0° C., 20° C., or 40° C. In some embodiments, the storage environment has a relative humidity of 0% to 90%; in specific examples, it may be 10%, 30%, 50%, or 70%. Storage under these conditions prevents aging or performance degradation of the three-dimensional printing consumable.

The method for preparing the three-dimensional printing consumable according to the present disclosure offers advantages such as a wide range of material choices, flexible and controllable processes, and excellent performance. Specific parameters of the fibers, such as diameter, tension, and weight ratio, can be adjusted within a broad range according to actual requirements. The types of continuous fibers and sheath fibers are comprehensive, meeting diverse needs for the three-dimensional printing consumable across different fields and application scenarios.

The present disclosure further provides a three-dimensional printing method, including:
conducting three-dimensional printing using the continuous fiber-reinforced composite three-dimensional printing consumable or the continuous fiber-reinforced composite three-dimensional printing consumable prepared by the method.

In some embodiments of the present disclosure, parameters for three-dimensional printing include: a nozzle temperature of 100° C. to 400° C.; in specific examples, it may be 200° C. or 300° C.; a printing speed of 1 mm/s to 100 mm/s; in specific examples, it may be 5 mm/s, 10 mm/s, 30 mm/s, 50 mm/s, or 80 mm/s; and a layer thickness of 0.1 mm to 5 mm; in specific examples, it may be 0.5 mm, 1 mm, 2 mm, or 3 mm. By rationally setting the printing parameters, a stable and efficient printing process can be achieved, producing three-dimensional printed articles with excellent properties such as high strength, high stiffness, heat resistance, and corrosion resistance. Furthermore, by controlling the distribution and orientation of fibers within the three-dimensional printing consumable, directional design of product properties can be realized to meet specific requirements such as multi-axial load bearing, local reinforcement, and functional gradients.

In specific examples of the present disclosure, the three-dimensional printing consumable is installed into a feeding system of a three-dimensional printing equipment. Printing parameters are then set, and the feeding speed and direction of the three-dimensional printing consumable are controlled to ensure smooth feeding, maintaining the stability and continuity of the continuous fibers during the printing. Three-dimensional printing is conducted according to the preset printing path and model to prepare a three-dimensional printed article with enhanced mechanical properties and specific functions. In specific examples, post-processing techniques such as annealing, surface treatment, or other treatments may be applied to the obtained three-dimensional printed article as needed to enhance their performance.

The continuous fiber-reinforced composite three-dimensional printing consumable provided in the present disclosure can be widely used in the preparation of three-dimensional printed products requiring high performance and lightweight characteristics. In the aerospace field, it can manufacture high-strength, lightweight structural components like drone fuselages, satellite components, and rocket segments. In the automotive manufacturing field, it can produce high-performance automotive parts like body structural components, suspension system parts, and interior trim, improving vehicle performance and fuel efficiency. In the medical device field, it can prepare biodegradable and biocompatible medical supplies like orthopedic implants, tissue engineering scaffolds, and drug delivery systems. In the industrial manufacturing field, it can create high-strength, wear-resistant industrial parts like gears, bearings, and pump housings, extending service life and reducing maintenance costs. In the electronic device field, it can print electronic components with conductive properties, sensors, antennas, etc., achieving integration of structural and electronic functions. In the sports equipment field, it can manufacture high-performance sports gear like bicycle frames, skis, and rackets, enhancing athletic performance. In the construction engineering field, it can produce building components with special properties, such as seismic supports, insulation panels, and decorative materials.

The present disclosure further provides a three-dimensional printed article obtained by the three-dimensional printing method.

In some embodiments of the present disclosure, the three-dimensional printed article exhibits characteristics such as high strength, high modulus, heat resistance, flame retardancy, impact resistance, electrical conductivity, and antibacterial properties. They can be used long-term in high-temperature (−50° C. to 400° C.), high-humidity, and highly corrosive environments with stable performance, making them suitable for applications in aerospace, automotive manufacturing, medical devices, industrial manufacturing, electronic components, sports equipment, construction engineering, and national defense and military industries.

In some embodiments of the present disclosure, the three-dimensional printed article specifically includes one or more of aerospace equipment, automotive parts, medical devices, industrial mechanical components, electronic components, sports equipment, building structures, and military equipment.

In some embodiments of the present disclosure, the three-dimensional printed articles can undergo subsequent processing as needed, such as machining, coating, electroplating, and welding, further expanding their range of applications.

To further illustrate the present disclosure, the technical solutions provided by the present disclosure are described in detail below in connection with examples, but these examples should not be construed as limiting the claimed scope of the present disclosure.

### Example 1

Continuous carbon fiber with 3K monofilaments was selected as the core material. The monofilament diameter of the continuous carbon fiber was 7 μm, characterized by high strength and high modulus. Polyamide 6 (PA6) fiber with a melting point of 220° C. and a fiber diameter of 230 μm was chosen as the sheath fiber for weaving. The weaving machine was equipped with 16 weaving spindles and operated at a weaving speed of 30 r/min. The continuous carbon fiber was fed through the center of the weaving machine, with its tension controlled at 1 N to ensure stable delivery. The PA6 fibers were cross-weaved at a weaving angle of 45° to form a tubular structure, tightly wrapping the continuous carbon fiber. The tension of the PA6 fibers was controlled at 0.5 N, resulting in a continuous fiber-reinforced composite filament.

The continuous fiber-reinforced composite filament was passed through a tubular furnace set at 230° C. at a speed of 2 m/min for a heat treatment, with a heat treatment duration of 10 s. This temperature was slightly above the melting point of PA6, ensuring that the surface layer of the polymer fibers was melted and bonded together, forming a dense composite structure. After exiting the furnace, the material immediately entered a cooling zone where it was rapidly set through air cooling. The cooled three-dimensional printing consumable was wound onto spools using an automatic winding machine, whose winding speed was synchronized with the heat treatment speed to maintain constant tension. thereby preventing filament slack or deformation. The final three-dimensional printing consumable exhibited a uniform surface without significant bubbles or defects, with a uniform diameter of approximately 1.75 mm, where a mass ratio of the continuous fiber core material to the sheath fiber-braided sleeve was 20:80.

Mechanical performance test results showed that the obtained three-dimensional printing consumable achieved a tensile strength of 1,500 MPa and a bending strength of 1,200 MPa, which were significantly higher than those of pure PA material.

The three-dimensional printing consumable was applied to a commercial FDM three-dimensional printer with a maximum print head temperature of 280° C. The printing parameters were set as follows: a nozzle temperature of 250° C., a printing speed of 2-50 mm/s, and a layer thickness of 0.2-3 mm. During the printing, the filaments were fed smoothly without clogging or fiber breakage. The resulting printed articles exhibited high strength and stiffness, with desirable surface quality, meeting the requirements for high-performance structural components.

### Example 2

Continuous glass fiber with 1K filaments was selected as the core material. The monofilament diameter of the continuous glass fiber was 9 μm. Water-soluble PVA fiber with a diameter of 15 μm was chosen as the sheath fiber for weaving. The number of spindles for the weaving was 8, and the weaving speed was 20 r/min. The continuous glass fiber was fed through the center of the weaving machine, with its tension controlled at 0.8 N to ensure stable delivery. The PVA fibers were cross-weaved at a weaving angle of 30° to form a tubular structure, tightly wrapping the glass fiber. The tension of the PVA fibers was controlled at 0.4 N, obtaining a continuous fiber-reinforced composite filament.

The continuous fiber-reinforced composite filament was immersed in a solvent tank containing pure water at 85° C. for 5 min. The PVA fibers were partially dissolved in pure water, becoming viscous and tightly adhering to and appropriately covering the surface of the continuous glass fiber. Subsequently, the composite filament was removed from the solvent and placed in a ventilated environment to allow residual solvent to evaporate naturally. To ensure complete solvent evaporation and setting, the composite filament was dried in a forced-air drying oven at 50° C. for 2 h. The three-dimensional printing consumable obtained after drying exhibited a smooth surface and uniform diameter of approximately 2 mm, where a mass ratio of the continuous fiber core material to the sheath fiber-braided sleeve was 25:75.

Mechanical performance test results showed that the obtained three-dimensional printing consumable achieved a tensile strength of 800 MPa and a bending strength of 600 MPa.

The three-dimensional printing consumable was applied to an FDM three-dimensional printer with a nozzle diameter of 1.2 mm, with a printing head suitable for water-soluble materials, where printing parameters were set as follows: a nozzle temperature of 220° C., a printing speed of 30 mm/s, and a layer thickness of 0.25 mm. The printing proceeded smoothly, and the printed articles formed well. After printing, the articles could be washed with water to remove residual PVA, improving its purity and performance.

### Example 3

The continuous fiber core material was a 12K basalt/aramid hybrid fiber bundle, with a weight ratio of a basalt fiber and an aramid fiber being 1:1, both having a monofilament diameter of 10 μm. Polylactic acid (PLA) fiber with a melting point of 170° C. and a diameter of 25 μm was selected as the sheath fiber for weaving, with the weaved sleeve consisting of 2 layers. A weaving machine was used, where the number of spindles for the inner layer was 16, and the number of spindles for the outer layer was 24, operating at a weaving speed of 30 r/min. The basalt/aramid hybrid fiber bundle was fed through the center of the weaving machine, with its tension controlled at 0.6 N to ensure stable delivery. The inner layer PLA fibers were weaved at a weaving angle of 40° to form an inner weaved sleeve, tightly wrapping the core material. Additional PLA fibers were then weaved at a weaving angle of 50° around the inner weaved sleeve to form an outer weaved sleeve, further enhancing the structural stability, obtaining a continuous fiber-reinforced composite filament.

The continuous fiber-reinforced composite filament was placed in a steam fumigation treatment chamber with steam temperature set at 180° C. for a treatment duration of 10 min. Under the influence of high-temperature steam, the PLA fibers were softened and melted, covering and penetrating between the continuous fibers to form a dense composite structure. After the steam fumigation treatment, the composite filament was removed and cooled naturally at room temperature to complete the setting process. The final three-dimensional printing consumable exhibited a uniform surface, consistent color, and a diameter of approximately 2.5 mm, where a mass ratio of the continuous fiber core material to the sheath fiber-braided sleeve was 55:45.

Mechanical performance test results showed that the obtained three-dimensional printing consumable achieved a tensile strength of 1,000 MPa and a bending strength of 800 MPa.

The three-dimensional printing consumable was applied to a commercial FDM three-dimensional printer. The printing parameters were set as follows: a nozzle temperature of 200° C., a printing speed of 35 mm/s, and a layer thickness of 0.6 mm. The printing process was stable, and the printed products demonstrated high precision, excellent strength, and heat resistance, combining the superior properties of both basalt and aramid fibers, making them suitable for high-performance applications.

### Example 4

All conditions in this example were the same as those in Example 1, except that:
The continuous fiber core material was replaced with 12K carbon fibers (with a monofilament diameter of 7 μm, and a tensile strength of 4,900 MPa) and 24K glass fibers (with a monofilament diameter of 13 μm, and a tensile strength of 3,450 MPa), with a weight ratio of the carbon fibers to the glass fibers of 1:1. The weaving angle of the PA6 fibers was set to 60°. The obtained three-dimensional printing consumable exhibited a tensile strength of 1,600 MPa, a bending strength of 1,300 MPa, and an impact strength of 85 kJ/m², combining high strength and high toughness.

### Example 5

All conditions in this example were the same as those in Example 1, except that:
The continuous fiber core material was replaced with 16K basalt fibers (with a monofilament diameter of 11 μm, and a tensile strength of 4,800 MPa) and Kevlar aramid fibers (with a monofilament diameter of 12 μm, and a tensile strength of 3,600 MPa), with a weight ratio of the basalt fibers to the Kevlar aramid fibers being 1:1.

The sheath fiber was PEEK fiber with a diameter of 50 μm, and weaved at a weaving angle of 45°. The heat treatment was conducted at 370° C. for 10 min.

The obtained three-dimensional printing consumable exhibited a heat distortion temperature of 280° C. and an impact strength of 90 kJ/m², demonstrating outstanding heat resistance along with high impact resistance.

### Example 6

All conditions in this example were the same as those in Example 1, except that:
The weaving angle of the PA6 fibers was changed to 30° or 60°. The results showed that a weaving angle of 30° improved the flexibility of the three-dimensional printing consumable, making it suitable for applications requiring bending.

Under a condition that the weaving angle was set to 60°, the fibers were more tightly interweaved in the radial direction, enhancing the strength and stability of the three-dimensional printing consumable, making it suitable for high-strength applications.

### Example 7

All conditions in this example were the same as those in Example 1, except that:
The sheath fiber was changed to PCL fiber with a diameter of 75 μm. The heat treatment was conducted at 60° C. for 5 min.

The obtained three-dimensional printing consumable required a printing temperature of only 70° C., enabling combination printing with continuous fiber core materials that cannot withstand high-temperature processing.

### Example 8

All conditions in this example were the same as those in Example 2, except that:
The step of using water for the setting treatment was omitted. The weaved continuous fiber-reinforced composite filament was directly used as the three-dimensional printing consumable. The results showed that the obtained consumable could be directly used for printing, but with a slight decrease in feeding stability. The surface smoothness of the printed articles was slightly lower than that in Example 2, and occasional jamming occurred. Nevertheless, it still fully met the requirements for printing.

### Example 9

In this example, an eccentric continuous fiber-reinforced composite three-dimensional printing consumable was prepared, where the continuous fiber core material was deliberately positioned off-center in the cross-section of the consumable to meet specific functional requirements, such as enhancing local performance or achieving functional gradients.

A 3K continuous carbon fiber was selected as the core material, with a monofilament diameter of 7 μm, exhibiting excellent characteristics of high strength and high modulus. The sheath polymer fiber was PA6 fiber with a melting point of 220° C. and a diameter of 20 μm, used for weaving. To achieve the eccentric structure, the weaving machine for the weaved sleeve was modified by relocating the core material inlet from the center to an off-center position. Specifically, the angle and position of the core material guide tube were adjusted to bring it closer to the edge of the weaving zone, thereby introducing the continuous carbon fiber to the side edge of the weaved sleeve during the weaving process. Additionally, a PA6 fiber was incorporated alongside the core material to assist in maintaining the eccentric position of the continuous carbon fiber. The weaving machine was equipped with 16 weaving spindles and operated at a weaving speed of 30 r/min. The continuous carbon fiber was fed through the eccentric guide tube at a constant tension of 1 N, while the PA6 fibers were cross-weaved at a weaving angle of 45° with a tension controlled at 0.5 N, forming a tubular structure that tightly wrapped the carbon fiber, resulting in a continuous fiber-reinforced composite three-dimensional printing consumable. Due to the skewing of the inlet position, the continuous carbon fiber was located in the edge region of the weaved sleeve, forming an eccentric fiber-reinforced structure.

The weaved material was passed through a tubular furnace set at 230° C. at a speed of 2 m/min for heat treatment, with a duration of 10 s. This temperature was slightly above the melting point of PA6, ensuring complete melting of the polymer fibers. The molten PA6 fibers covered and penetrated the carbon fiber and surrounding areas, forming a dense composite structure. After exiting the furnace, the consumable immediately entered a cooling zone where it was rapidly set through air cooling. As the continuous carbon fiber was off-center in the cross-section of the consumable, the molten PA6 fibers, after cooling and setting, formed a three-dimensional printing consumable with an asymmetric fiber distribution in the cross-section.

The cooled three-dimensional printing consumable was wound onto spools using an automatic winding machine, which has a winding speed synchronized with the heat treatment speed to maintain constant tension and prevent filament slack or deformation. The final three-dimensional printing consumable exhibited a smooth surface and uniform diameter of approximately 1.75 mm, where a mass ratio of the continuous fiber core material to the sheath fiber-braided sleeve was 35:65, and the eccentric distribution of fibers was observable in the cross-section.

Mechanical performance test results showed that the obtained eccentric three-dimensional printing consumable achieved a tensile strength of 1,400 MPa along the fiber-reinforced region, slightly lower than that of centrally distributed continuous fiber-reinforced consumables but still significantly higher than that of pure PA materials. The bending performance exhibited anisotropy, with higher stiffness and strength in the fiber-reinforced region.

The eccentric three-dimensional printing consumable was applied to a commercial FDM three-dimensional printer with a maximum print head temperature of 280° C. The printing parameters were set to a nozzle temperature of 250° C., a printing speed of 40 mm/s, and a layer thickness of 0.6 mm. During printing, attention was paid to the feeding direction of the filament to ensure that the fiber-reinforced region was oriented toward the direction requiring reinforcement in the printed product. The three-dimensional printing consumable was fed smoothly without clogging or fiber breakage. The final printed article exhibited higher strength and stiffness in the fiber-reinforced region, making it suitable for structural components requiring local reinforcement. By adjusting the printing path and the feeding direction of the consumable, directional design of the mechanical properties of the product could be achieved. This example realized a successful preparation of an eccentric continuous fiber-reinforced three-dimensional printing consumable through modifications to the weaving equipment and adjustments to process parameters. This method broadened the application scope of the present disclosure and provided new possibilities for the performance design and optimization of three-dimensional printed articles, holding significant application value.

### Example 10

In this example, a continuous fiber-reinforced composite three-dimensional printing consumable was prepared with a multi-layer nested structure. A 12K carbon fiber bundle was used as the inner continuous fiber core material, specifically T700S carbon fiber with a monofilament diameter of 7 μm, with a tensile strength of 4,900 MPa, a tensile modulus of 230 GPa, and an elongation at break of 2.1%. A 24K glass fiber bundle was used as the outer continuous fiber core material, with a monofilament diameter of 13 μm, supplied by Owens Corning alkali-free glass fiber, a tensile strength of 3,450 MPa, a tensile modulus of 73 GPa, and an elongation at break of 4.7%. PLA fiber was used as the inner polymer fiber with a diameter of 20 μm and a melting point of 170° C. The outer polymer fiber was PA6 fiber with a diameter of 20 μm and a melting point of 220° C.

A multi-layer weaving machine was used. The 12K carbon fiber bundle was fed through a fiber guiding device at a tension of 1 N and introduced to the inner core material position of the weaving machine. Subsequently, PLA fibers were weaved at a tension of 0.5 N using 16 weaving spindles at a weaving angle of 30° to form a tubular structure, interweaving the carbon fibers and PLA fibers to create an inner embedded structure. Outer layer weaving was then conducted:
based on the completed inner layer weaving, the 24K glass fiber bundle was fed through a fiber guiding device at a tension of 1 N and introduced to the outer weaving zone, advancing synchronously with the inner layer material. PA6 fibers were then weaved at a tension of 0.5 N using 24 weaving spindles at a weaving angle of 60°, wrapping the outside of the inner layer and interweaving the glass fibers with PA6 fibers to form an outer embedded structure, resulting in a composite filament.

A staged heat treatment was conducted for the setting treatment. The weaved composite filament was passed through a tubular furnace at a speed of 1 m/min. The first-stage heating temperature was set to 180° C. (10° C. above the melting point of PLA), with a heating length of 1 m and heating time of approximately 1 min, aiming to melt the inner PLA fibers to cover and penetrate between the carbon fibers. The second-stage heating temperature was raised to 230° C. (10° C. above the melting point of PA6), with a heating length of 1 m and heating time of approximately 1 min, aiming to melt the outer PA6 fibers to cover and penetrate between the glass fibers. The material then immediately entered a segmented cooling system and was cooled therein. At the first cooling segment, the temperature was reduced from 230° C. to 150° C., with a length of 1 m and cooling time of approximately 1 min. At the second cooling segment, the temperature was cooled from 150° C. to room temperature, with a length of 1 m and cooling time of approximately 1 min. The purpose of segmented cooling was to gradually reduce the temperature, minimize internal stress, and prevent deformation of the filament. To impart flame retardancy to the three-dimensional printing consumable, surface treatment was conducted. The cooled filament was passed through a dip-coating device to apply a flame-retardant coating on its surface. The coating material was a halogen-free flame retardant solution (solvent: deionized water, and a flame retardant concentration: 10%), with a dip-coating time of 5 s. Subsequently, the coated filament entered a tunnel-type drying oven set at 100° C. for a drying time of 30 min to ensure complete solvent evaporation and uniform coating adhesion.

Finally, an automatic winding machine was used to coil the processed multi-layer nested three-dimensional printing consumable onto spools at a winding tension of 20 N. The spools were stored in a dry, light-proof environment at 20° C. with relative humidity below 50% to prevent material aging or performance degradation. The prepared multi-layer nested three-dimensional printing consumable had a diameter of 2.5 mm, with fiber weight proportions as follows: carbon fibers accounting for 20%, glass fibers accounting for 30%, PLA polymer accounting for 25%, and PA6 polymer accounting for 25%.

Mechanical performance test results showed that the obtained multi-layer nested three-dimensional printing consumable achieved a tensile strength of 1,800 MPa, a tensile modulus of 150 GPa, a bending strength of 1,500 MPa, a bending modulus of 120 GPa, and an impact strength of 80 kJ/m². Thermal performance tests showed a heat distortion temperature (HDT) of 200° C. and a glass transition temperature (T_{g}) of 85° C. for the three-dimensional printing consumable. In terms of functional properties, the flame retardancy reached UL94 V-0 rating, and the corrosion resistance was excellent, with no significant performance degradation after immersion in acid or alkali solutions for 24 h.

In the three-dimensional printing application, an FDM three-dimensional printer with a nozzle diameter of 1.5 mm was used. The nozzle temperature was set to 240° C., the printing bed temperature was set to 80° C., the printing speed was set to 30 mm/s, and the layer thickness was set to 0.8 mm. The prepared multi-layer nested three-dimensional printing consumable was installed into a feeding system of the printer to ensure smooth filament feeding. Printing parameters were set to accommodate the characteristics of this multi-layer nested three-dimensional printing consumable, the printing model was loaded, and printing commenced. Due to the high strength and high modulus of the multi-layer nested three-dimensional printing consumable, printing speed and nozzle temperature were adjusted during the printing to prevent warping caused by overheating or rapid cooling. After printing, the article was cooled to room temperature before removal. The printed article exhibited excellent mechanical properties, with tensile strength thereof reaching above 1,500 MPa, meeting the requirements for high-strength applications. In terms of thermal performance, the article maintained dimensional stability in high-temperature environments of 150° C. to 200° C., making it suitable for manufacturing high-temperature-resistant components. Its flame retardancy was also excellent, suitable for applications in fields exposing high fire safety requirements.

From the above examples, it can be seen that the combination of materials and the adjustment of process parameters have an important impact on the performance of the final product. In terms of materials, the type and combination of fibers can effectively regulate the strength, toughness and heat resistance of the filament.

Although the present disclosure is described in detail in conjunction with the foregoing examples, they are only a part of, not all of, the examples of the present disclosure. Other examples can be obtained based on these examples without creative efforts, and all of these examples shall fall within the scope of the present disclosure.

What is claimed is:

1. A continuous fiber-reinforced composite three-dimensional printing consumable, comprising: a continuous fiber core material and a sheath fiber-braided sleeve; wherein the continuous fiber core material is wrapped in a lumen of the sheath fiber-braided sleeve, and/or the continuous fiber core material is interweaved within a sleeve wall of the sheath fiber-braided sleeve;
the continuous fiber core material comprises one or more selected from the group consisting of a carbon fiber, a glass fiber, a basalt fiber, a polymer fiber, a metal fiber, a ceramic fiber, and a bio-based fiber; and
a sheath fiber used for the sheath fiber-braided sleeve is a polymer fiber, and the sheath fiber-braided sleeve is a weaved sleeve and/or a knitted sleeve, with a weaving angle or a knitting angle of 5° to 85°;
a number of layers in the sleeve wall of the sheath fiber-braided sleeve is ≥1; and a mass ratio of the continuous fiber core material to the sheath fiber-braided sleeve is in a range of 1-80:20-99;
under a condition that the continuous fiber core material is wrapped in the lumen of the sheath fiber-braided sleeve, a distribution pattern of the continuous fiber core material in a cross-section of a three-dimensional printing consumable is eccentric distribution; the continuous fiber-reinforced composite three-dimensional printing consumable further comprises an auxiliary positioning fiber; the auxiliary positioning fiber and the continuous fiber core material are collectively wrapped within the lumen of the sheath fiber-braided sleeve; and the auxiliary positioning fiber and the continuous fiber core material are arranged in parallel or intertwined.

2. The continuous fiber-reinforced composite three-dimensional printing consumable as claimed in claim 1, wherein the sheath fiber comprises one or more selected from the group consisting of a polyamide (PA) fiber, a polypropylene (PP) fiber, a polyethylene (PE) fiber, a polylactic acid (PLA) fiber, a polycaprolactone (PCL) fiber, a polyvinyl alcohol (PVA) fiber, a polyether ether ketone (PEEK) fiber, a polyimide (PI) fiber, a polyphenylene sulfide (PPS) fiber, a polycarbonate (PC) fiber, a polyethylene terephthalate (PET) fiber, a polyvinyl chloride (PVC) fiber, a blended polymer fiber, and a modified polymer fiber.

3. The continuous fiber-reinforced composite three-dimensional printing consumable as claimed in claim 1, wherein the polymer fiber used in the continuous fiber core material comprises one or more selected from the group consisting of an aramid fiber, a poly(p-phenylene benzobisoxazole) fiber, a PE fiber, a polyester fiber, a PI fiber, and a PA fiber;
the metal fiber comprises one or more selected from the group consisting of a copper fiber, an aluminum fiber, and a tungsten fiber;
the ceramic fiber comprises an alumina fiber and/or a silicon carbide fiber;
the bio-based fiber comprises a bamboo fiber and/or a flax fiber; and
the continuous fiber core material is selected from the group consisting of a fiber monofilament and a fiber bundle; and a number of the continuous fiber core material is at least one.

4. The continuous fiber-reinforced composite three-dimensional printing consumable as claimed in claim 1, wherein the continuous fiber core material comprises a functional polymer fiber; and the functional polymer fiber comprises one or more selected from the group consisting of a conductive fiber, a flame-retardant fiber, an antibacterial fiber, and a fluorescent fiber.

5. A method for preparing the continuous fiber-reinforced composite three-dimensional printing consumable as claimed in claim 1, comprising:
braiding according to a predetermined structure using the sheath fiber and the continuous fiber core material as raw materials to obtain the continuous fiber-reinforced composite three-dimensional printing consumable; alternatively,
braiding according to the predetermined structure using the sheath fiber, the continuous fiber core material, and the auxiliary positioning fiber as raw materials to obtain the continuous fiber-reinforced composite three-dimensional printing consumable; wherein the braiding is performed by weaving or knitting, and an angle of the weaving or the knitting is in a range of 5° to 85°.

6. The method as claimed in claim 5, wherein a number of spindles for the weaving is 4 to 200; a number of needles for the knitting is 4 to 200; and the sheath fiber is arranged in an annular pattern or a spiral pattern.

7. The method as claimed in claim 5, further comprising: after the braiding, subjecting a consumable obtained from the braiding to a setting treatment and/or a surface treatment; wherein a process for the setting treatment comprises one selected from the group consisting of a heat treatment, a solvent treatment, a steam fumigation treatment, and an ultraviolet curing treatment; and
a process for the surface treatment is one selected from the group consisting of a plasma treatment and formation of a functional layer on a surface of the consumable obtained from the braiding; and the functional layer comprises one or more selected from the group consisting of a lubricating layer, an anti-oxidation layer, an anti-static layer, a flame-retardant layer, a conductive layer, and an antibacterial layer.

8. A three-dimensional printing method, comprising: conducting three-dimensional printing using the continuous fiber-reinforced composite three-dimensional printing consumable as claimed in claim 1.

9. A three-dimensional printed article obtained by the three-dimensional printing method as claimed in claim 8.

10. The method as claimed in claim 5, wherein the sheath fiber comprises one or more selected from the group consisting of a polyamide (PA) fiber, a polypropylene (PP) fiber, a polyethylene (PE) fiber, a polylactic acid (PLA) fiber, a polycaprolactone (PCL) fiber, a polyvinyl alcohol (PVA) fiber, a polyether ether ketone (PEEK) fiber, a polyimide (PI) fiber, a polyphenylene sulfide (PPS) fiber, a polycarbonate (PC) fiber, a polyethylene terephthalate (PET) fiber, a polyvinyl chloride (PVC) fiber, a blended polymer fiber, and a modified polymer fiber.

11. The method as claimed in claim 5, wherein the polymer fiber used in the continuous fiber core material comprises one or more selected from the group consisting of an aramid fiber, a poly(p-phenylene benzobisoxazole) fiber, a PE fiber, a polyester fiber, a PI fiber, and a PA fiber;
the metal fiber comprises one or more selected from the group consisting of a copper fiber, an aluminum fiber, and a tungsten fiber;
the ceramic fiber comprises an alumina fiber and/or a silicon carbide fiber;
the bio-based fiber comprises a bamboo fiber and/or a flax fiber; and
the continuous fiber core material is selected from the group consisting of a fiber monofilament and a fiber bundle; and a number of the continuous fiber core material is at least one.

12. The method as claimed in claim 5, wherein the continuous fiber core material comprises a functional polymer fiber; and the functional polymer fiber comprises one or more selected from the group consisting of a conductive fiber, a flame-retardant fiber, an antibacterial fiber, and a fluorescent fiber.
